(19) United States
(12) Patent Application Publication
(10) Pub. No.: US 2012/0235071 A1
(43) Pub. Date: Sep. 20, 2012

(54) POLYIMIDE RESINS FOR HIGH TEMPERATURE WEAR APPLICATIONS

(75) Inventors: Jesus G. Moralez, Wilmington, DE (US); Susan H. Tilford, Ewing, NJ (US); Robert Ray Burch, Exton, PA (US); Shekhar Subramoney, Hockessin, DE (US)

(73) Assignee: E.I. DU PONT DE NEMOURS AND COMPANY, Wilmington, DE (US)

(21) Appl. No.: 13/504,317

(22) PCT Filed: Oct. 27, 2010
(86) PCT No.: PCT/US10/54288

§ 371 Date: May 25, 2012

(51) Int. Cl. C08K 3/10; C08K 3/38; E04B 1/74; C09K 5/00; H01B 1/12; C08L 79/08; C08K 3/04; B82Y 30/00

(52) U.S. Cl. 252/62; 524/600; 524/435; 524/404; 524/496; 252/71; 252/500; 977/762

(57) ABSTRACT

Polyimide resin compositions that contain an end-capped rigid aromatic polyimide, graphite and carbon filaments are found to exhibit low wear at high temperatures. Such compositions are especially useful in molded articles that are exposed to wear conditions at high temperatures such as aircraft engine parts.

This application claims priority under 35 U.S.C. §119(e) from, and claims the benefit of, U.S. Provisional Application No. 61/255,147, filed Oct. 27, 2010, which is by this reference incorporated in its entirety as a part hereof for all purposes.

### TECHNICAL FIELD

This disclosure relates to filled polyimide resin compositions that are useful for high temperature wear applications such as aircraft engine parts.

### BACKGROUND

The unique performance of polyimide compositions under stress and at high temperatures have made them useful in applications requiring high wear resistance, particularly at conditions of high pressure and velocity. Some examples of such applications are aircraft engine parts, aircraft wear pads, automatic transmission bushings and seal rings, tenter frame pads and bushings, material processing equipment parts, and pump bushings and seals.

Typically, a polyimide component in applications as described above is intended to function as a sacrificial, or consumable, component, thereby preventing or reducing the wear or damage that a more costly mating or adjacent component would experience if it were mated against some other component. However, as the polyimide component wears, the resulting increased clearances can result in other adverse effects, such as increased leakage (of air pressure or fluid) or increased noise, thereby reducing the operating effectiveness of the entire system in which the polyimide component is contained. Restoring the system to its original operating effectiveness would require replacement of the worn polyimide component with a new un-used polyimide component. Replacement may require disassembly, reassembly, testing and re-calibration (“service”) of the system, resulting in considerable costs in terms of down-time and labor. Thus, a polyimide component that demonstrates a lower rate of wear is desirable to reduce the frequency of replacement and service, thereby reducing cost.

Improvement in thermooxidative stability (“TOS”) as a consequence of end-capping has been found in polyimides containing flexible linkages [see, e.g., Meador et al., Macromolecules, 37 (2004), 1289-1296]. End-capping has actually been found to decrease TOS in certain rigid aromatic polyimide compositions, however. Despite the variety of polyimide compositions, and fillers for same, that have previously been available, and despite the previous work in the art, a need still remains for polyimide compositions that exhibit as molded parts the desirably high degree of wear resistance at the higher temperatures and increased pressure velocity load currently required for applications such aircraft engine parts, while maintaining the other advantageous attributes of the polyimide material.

### SUMMARY

In one embodiment, this invention provides a composition that includes in admixture (a) about 40 weight parts or more and yet about 92 weight parts or less of a rigid polyimide that is end-capped with phthalic anhydride, or a derivative of phthalic anhydride, as represented by the structure of the following Formula (IV):

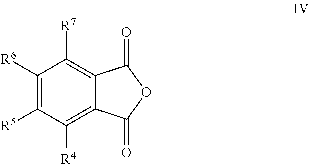

wherein R⁴, R⁵, R⁶, and R⁷ are each independently H, Br, Cl, F, alkyl, alkoxy, or fluoroalkyl; (b) about 8 weight parts or more and yet about 60 weight parts or less graphite; and (c) about 0.5 weight parts or more and yet about 10.0 weight parts or less of carbon filament.

In another embodiment, this invention provides a composition that includes (a) about 40 weight parts or more and yet about 92 weight parts or less of an aromatic polyimide, wherein the polyimide is end-capped with phthalic anhydride or a derivative of phthalic anhydride, (b) about 8 weight parts or more and yet about 60 weight parts or less graphite, and (c) about 0.5 weight parts or more and yet about 10 weight parts or less of carbon filament; where weight parts (a), (b), and (c) combined together total to 100 weight parts.

In certain other embodiments, the carbon filament may have one or more of the following properties: an average diameter of about 70 to about 400 nm, an average length of about 5 to about 100 μm, and an aspect ratio of at least about 50.

Articles fabricated from the above described compositions are also provided.

### BRIEF DESCRIPTION OF THE DRAWINGS

Various features and/or embodiments of this invention are illustrated in drawings as described below. These features and/or embodiments are representative only, and the selection of these features and/or embodiments for inclusion in the drawings should not be interpreted as an indication that subject matter not included in the drawings is not suitable for practicing the invention, or that subject matter not included in the drawings is excluded from the scope of the appended claims and equivalents thereof.

FIG. 1 is a computer graphic showing uppermost a hexagonal graphene layer as a tapered tube, as known in the art, and below a stack of about 16 of such tubes.

FIG. 2 is a schematic view of a partial cut-away of a stack of eight tapered tubes, as known in the art.

FIG. 3 is a schematic view of three areas of film of carbon over the outer surface of a stack as in FIG. 2.

FIG. 4 shows a schematic view of a section of a concentric multiwall carbon nanotube, as known in the art.

FIG. 5 shows a schematic view of a section of a spiral-wrapped multiwall carbon nanotube, as known in the art.

FIG. 6 is a schematic drawing of the stages of a catalyst, as known in the art, producing carbon filament types.

FIG. 7 is a transmission electron microscope image of mixture CF-CN showing carbon filaments and an iron particle.

FIG. 8 is a transmission electron microscope image of mixture CF-CN showing carbon filaments with a stacked lampshade configuration, sometimes with an outer layer of multiwall axial carbon layers, and a carbon filament with a distinct bend having defect sites.

FIG. 9 is a transmission electron microscope image of mixture CF-A showing a broken carbon filament with a narrow bore.

FIGS. 10A and 10B show a transmission electron microscope image of mixture CF-A showing two magnifications of a multiwall axial carbon filament without lampshade stacking, with an arrow pointing toward a defect site.

FIGS. 11A and 11B show another carbon filament view as in FIG. 10.

FIGS. 12A and 12B show a transmission electron microscope image of mixture CF-CN showing two magnifications of a carbon filament having a distinct bore of relatively large diameter with respect to the outer filament diameter, with an arrow pointing toward a defect site.

FIGS. 13A and 13B show a transmission electron microscope image of mixture CF-CN showing two magnifications of a bent carbon filament having a distinct bore of relatively small diameter with respect to the outer filament diameter, with an arrow pointing toward a defect site.

FIGS. 14A and 14B show a transmission electron microscope image of mixture CF-CP showing two magnifications of a carbon filament, with an arrow pointing toward a minor defect site on the outer multiwall axial graphene layers or scroll, enclosing angled graphene inner layers.

FIGS. 15A and 15B show a transmission electron microscope image of mixture CF-CP showing two magnifications of a carbon filament, with an arrow pointing toward a defect site on the outer multiwall graphene layers or scroll, enclosing angled graphene inner layers.

FIGS. 16A and 16B show a transmission electron microscope image of mixture CF-CP showing two magnifications of a carbon filament, with a vertical arrow pointing toward an angled defect site on the outer multiwall graphene layers of a “bamboo-like” carbon filament.

FIGS. 17A˜E are scanning electron microscope images of mixture CF-A.

FIGS. 18A˜C are transmission electron microscope images of mixture CF-A.

FIGS. 19A˜E are scanning electron microscope images of mixture CF-CP.

FIGS. 20A˜C are transmission electron microscope images of mixture CF-CP.

FIGS. 21A˜D are scanning electron microscope images of mixture CF-CN.

FIGS. 22A˜C are transmission electron microscope images of mixture CF-CN.

### DETAILED DESCRIPTION

Disclosed herein is a composition that includes in admixture (a) about 40 weight parts to about 92 weight parts of a rigid polyimide that is end-capped with phthalic anhydride, or a derivative of phthalic anhydride, as represented by the structure of the following Formula (IV):

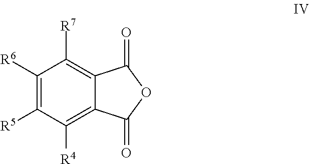

wherein R⁴, R⁵, R⁶, and R⁷ are each independently H, Br, Cl, F, alkyl, alkoxy, or fluoroalkyl; (b) about 8 weight parts to about 60 weight parts graphite; and (c) about 0.5 weight parts to about 10.0 weight parts of carbon filament.

Also disclosed herein are compositions that contain (a) a rigid aromatic polyimide, wherein the rigid aromatic polyimide is end-capped with phthalic anhydride or a derivative of phthalic anhydride, (b) graphite, and (c) a carbon filament having an average diameter of about 70 to about 400 nm, an average length of about 5 to about 100 μm, and/or an aspect ratio (i.e. length over diameter) of at least about 50.

A polyimide as used as the component “(a)” in a composition hereof is polymer in which at least about 80%, preferably at least about 90%, and more preferably essentially all (e.g. at least about 98%) of the linking groups between repeat units are imide groups. An aromatic polyimide as used herein includes an organic polymer in which about 60 to about 100 mol %, preferably about 70 mol % or more, and more preferably about 80 mol % or more of the repeating units of the polymer chain thereof have a structure as represented by the following Formula (I):

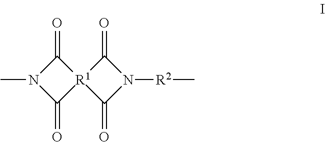

wherein R¹ is a tetravalent aromatic radical and R² is a divalent aromatic radical, as described below.

A polyimide as used herein is a rigid, preferably aromatic, polyimide. A polyimide polymer is considered rigid when there are no, or an insignificant amount (e.g. less than 10 mol %, less than 5 mol %, less than 1 mol % or less than 0.5 mol %) of, flexible linkages in the polyimide repeating unit. Flexible linkages are moieties that are predominantly composed of a small number of atoms, and that have an uncomplicated structure (such as straight-chain rather than branched or cyclic), and thus permit the polymer chain to bend or twist with relative ease at the location of the linkage. Examples of flexible linkages include without limitation: —o—, —N(H)—C(O)—, —S—, —SO₂—, —C(O)—, —C(O)—O—, —C(CH₃)₂—,

### —C(CF₃)₂—, —(CH₂)—, and —NH(CH₃)—.

A polyimide polymer suitable for use herein may be synthesized, for example, by reacting a monomeric aromatic diamine compound (which includes derivatives thereof) with a monomeric aromatic tetracarboxylic acid compound (which includes derivatives thereof), and the tetracarboxylic acid compound can thus be the tetracarboxylic acid itself, the corresponding dianhydride, or a derivative of the tetracarboxylic acid such as a diester diacid or a diester diacidchloride. The reaction of the aromatic diamine compound with an aromatic tetracarboxylic acid compound produces the corresponding polyamic acid (“PAA”), amic ester, amic acid ester, or other reaction product according to the selection of starting materials. An aromatic diamine is typically polymerized with a dianhydride in preference to a tetracarboxylic acid, and in such a reaction a catalyst is frequently used in addition to a solvent. A nitrogen-containing base, phenol or an amphoteric material can be used as such a catalyst.

A polyamic acid, as a precursor to a polyimide, can be obtained by polymerizing an aromatic diamine compound and an aromatic tetracarboxylic acid compound, preferably in substantially equimolar amounts, in an organic polar solvent that is generally a high-boiling solvent such as pyridine, N-methylpyrrolidone, dimethylacetamide, dimethylformamide or mixtures thereof. The amount of all monomers in the solvent can be in the range of about 5 to about 40 wt %, in the range of about 6 to about 35 wt %, or in the range of about 8 to about 30 wt %, based on the combined weight or monomers and solvent. The temperature for the reaction is generally not higher than about 100° C., and may be in the range of about 10° C. to 80° C. The time for the polymerization reaction generally is in the range of about 0.2 to 60 hours.

Imidization to produce the polyimide, i.e. ring closure in the polyamic acid, can then be effected through thermal treatment (e.g. as described in U.S. Pat. No. 5,886,129), chemical dehydration or both, followed by the elimination of a condensate (typically, water or alcohol). For example, ring closure can be effected by a cyclization agent such as pyridine and acetic anhydride, picoline and acetic anhydride, 2,6-lutidine and acetic anhydride, or the like.

In various embodiments of the thus-obtained polyimide, about 60 to 100 mole percent, preferably about 70 mole percent or more, more preferably about 80 mole percent or more, of the repeating units of the polymer chain thereof have a polyimide structure as represented by the structure of the following Formula (I):

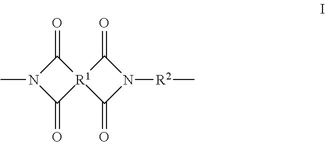

wherein R¹ is a tetravalent aromatic radical derived from the tetracarboxylic acid compound; and R² is a divalent aromatic radical derived from the diamine compound, which may typically be represented as H₂N—R²—NH₂.

A diamine compound as used to prepare a polyimide for a composition hereof may be one or more of the aromatic diamines that can be represented by the structure H₂N—R²—NH₂, wherein R² is a divalent aromatic radical containing up to 16 carbon atoms and, optionally, containing one or more (but typically only one) heteroatoms in the aromatic ring, a heteroatom being, for example, selected from —N—, —O—, or —S—. Also included herein are those R² groups wherein R² is a biphenylene group. Examples of aromatic diamines suitable for use to make a polyimide for a composition hereof include without limitation 2,6-diaminopyridine, 3,5-diaminopyridine, 1,2-diaminobenzene, 1,3-diaminobenzene (also known as m-phenylenediamine or “MPD”), 1,4-diaminobenzene (also known as p-phenylenediamine or “PPD”), 2,6-diaminotoluene, 2,4-diaminotoluene, naphthalenediamines, and benzidines such as benzidine and 3,3′-dimethylbenzidine. The aromatic diamines can be employed singly or in combination. In one embodiment, the aromatic diamine compound is 1,4-diaminobenzene (also known as p-phenylenediamine or “PPD”), 1,3-diaminobenzene (also known as m-phenylenediamine or “MPD”), or mixtures thereof.

Aromatic tetracarboxylic acid compounds suitable for use to prepare a polyimide for a composition hereof may include without limitation aromatic tetracarboxylic acids, acid anhydrides thereof, salts thereof and esters thereof. An aromatic tetracarboxylic acid compound may be as represented by the structure of the following Formula (II):

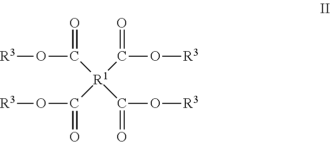

wherein R¹ is a tetravalent aromatic group and each R³ is independently hydrogen or a lower alkyl (e.g. a normal or branched C₁˜C₁₀, C₁˜C₈, C₁˜C₆ or C₁˜C₄) group. In various embodiments, the alkyl group is a C₁ to C₃ alkyl group. In various embodiments, the tetravalent organic group R¹ may have a structure as represented by one of the following formulae:

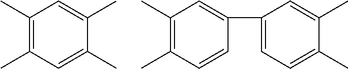

Examples of suitable aromatic tetracarboxylic acids include without limitation 3,3′,4,4′-biphenyltetracarboxylic acid, 2,3,3′,4′-biphenyltetracarboxylic acid, pyromellitic acid, 2,3,6,7-naphthalenetetracarboxylic acid, and 3,3′,4,4′-benzophenonetetracarboxylic acid. The aromatic tetracarboxylic acids can be employed singly or in combination. In one embodiment, the aromatic tetracarboxylic acid compound is an aromatic tetracarboxylic dianhydride. Examples include without limitation 3,3′,4,4′-biphenyltetracarboxylic dianhydride (“BPDA”), pyromellitic dianhydride (“PMDA”), 3,3,4,4′-benzophenonetetracarboxylic dianhydride, 1,4,5,8-naphthalenetetracarboxylic dianhydride, 2,3,6,7-naphthalenetetracarboxylic dianhydride, 1,4,5,8-naphthalenetetracarboxylic acid, 2,3,6,7-naphthalenetetracarboxylic acid, and mixtures thereof.

In one embodiment of a composition hereof, a suitable polyimide polymer may be prepared from 3,3′,4,4′-biphenyltetracarboxylic dianhydride (“BPDA”) as the aromatic tetracarboxylic acid compound, and from a mixture of p-phenylenediamine (“PPD”) and m-phenylenediamine (“MPD”) as the aromatic diamine compound. In one embodiment, the aromatic diamine compound is greater than 60 to about 85 mol % p-phenylenediamine and 15 to less than 40 mol % m-phenylenediamine. Such a polyimide is described in U.S. Pat. No. 5,886,129 (which is by this reference incorporated in its entirety as a part hereof for all purposes), and the repeat unit of such a polyimide may also be represented by the structure of the following Formula (III):

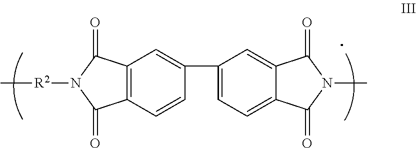

wherein greater than 60 to about 85 mol % of the R² groups are p-phenylene radicals:

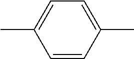

and 15 to less than 40 mol % are m-phenylene radicals:

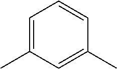

In an alternative embodiment, a suitable polyimide polymer may be prepared from 3,3′,4,4′-biphenyltetracarboxylic dianhydride (“BPDA”) as a dianhydride derivative of the tetracarboxylic acid compound, and 70 mol % p-phenylenediamine and 30 mol % m-phenylenediamine as the diamine compound.

A polyimide as used herein is preferably an infusible polymer, which is a polymer that does not melt (i.e. liquefy or flow) below the temperature at which it decomposes. Typically, parts prepared from a composition of an infusible polyimide are formed under heat and pressure, much like powdered metals are formed into parts (as described, for example, in U.S. Pat. No. 4,360,626, which is by this reference incorporated as a part hereof for all purposes).

A polyimide as used herein preferably has a high degree of stability to thermal oxidation. At elevated temperature, the polymer will thus typically not undergo combustion through reaction with an oxidant such as air, but will instead vaporize in a thermolysis reaction.

A rigid aromatic polyimide as used herein is end-capped with phthalic anhydride or a derivative of phthalic anhydride, as represented by the structure of the following Formula (IV):

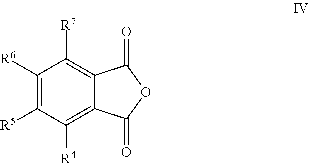

wherein R⁴, R⁵, R⁶, and le are each independently H, Br, Cl, F, alkyl, alkoxy, or fluoroalkyl. In one embodiment, R⁴, R⁵, R⁶, and le are each H (phthalic anhydride). In another embodiment, R⁴, R⁵, R⁶, and R⁷ are each Br (tetrabromophthalic anhydride).

The end-capping reaction is carried out by any convenient method such as by adding the end-capping agent [i.e. , phthalic anhydride or a derivative of phthalic anhydride, as represented by the structure of Formula (IV)] in a molar ratio of end-capping agent to aromatic tetracarboxylic acid compound of about 0.005 or more, about 0.0065 or more, about 0.008 or more, and yet about 0.03 or less, about 0.025 or less, or about 0.02 or less.

The end-capping agent (i.e. phthalic anhydride or a derivative of phthalic anhydride) may be added at any of various stages of preparation of the polyimide. For example, Srinivas et al [Macromolecules, 30 (1997), 1012-1022] in preparing a polyimide from BPDA and 1,3-bis(4-aminophenoxy)benzene reported adding the end-capping agent to a solution of the diamine, then adding dianhydride and allowing reaction to proceed for 24 hours at 25° C., thereby producing an end-capped polyamic acid which was subsequently imidized. Alternatively, and as generally described in Example 1 below, the end-capping agent and aromatic tetracarboxylic acid compound (e.g. a dianhydride) may be added together to a heated diamine solution (e.g. about 70° C.) and allowed to react for about 2 hours thereby producing an end-capped polyamic acid which is subsequently imidized.

End-capping a polyimide itself has also been reported, for example in JP 2004-123,857A, in which 4-chlorophthalic anhydride was added to a polyimide after imidization was complete. Use of an end-capping agent to cap, or stop the polymeric growth of, a polyimide hereof, produces an end-capped polyimide. Correspondingly, a polyimide into which an end-capping agent has not been incorporated is an uncapped polyimide.

An end-capped polyimide of this invention will desirably have a degree of polymerization (“DP”) of about 60 or greater, or in some embodiments about 80 or greater, or in some embodiments in the range of about 60 to about 150, or in some embodiments in the range of about 80 to about 120. The DP should not be so high as to raise the viscosity of the polyamic acid to a level at which it is unprocessible. Degree of polymerization is calculated according to the Carothers Equation, which is discussed in sources such as: Carothers, Wallace (1936) “Polymers and Polyfunctionality”, Transaction of the Faraday Society 32: 39-49; Cowie, J. M. G., “Polymers: Chemistry & Physics of Modern Materials” (2nd edition, Blackie 1991) p. 29; and Allcock, Lampe and Mark, “Contemporary Polymer Chemistry” (3rd ed., Pearson 2003) p. 324.

One method of preparing a wear resistant polyimide involves (a) contacting in a solvent an aromatic tetracarboxylic acid compound, an aromatic diamine compound, and a phthalic anhydride, or derivative thereof, as represented by the structure of the following Formula (IV):

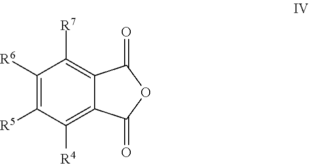

wherein R⁴, R⁵, R⁶, and R⁷ are each independently selected from H, Br, Cl, F, alkyl, alkoxy, or fluoroalkyl, to create a polyamic acid; and (b) imidizing the polyamic acid. In this method, graphite may also be admixed with the polyamic acid before the imidization of step (b).

Another method of preparing a wear resistant polyimide involves (a) end-capping, with phthalic anhydride, or a derivative of phthalic anhydride, as represented by the structure of the following Formula (IV)

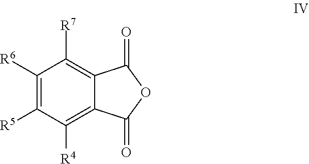

wherein R⁴, R⁵, R⁶, and R⁷ are each independently H, Br, Cl, F, alkyl, alkoxy, or fluoroalkyl, a rigid aromatic polyimide having a degree of polymerization (“DP”) of less than about 50 to form an end-capped polyimide; and (b) admixing the end-capped polyimide with an uncapped, rigid aromatic polyimide having a DP of greater than about 60, in a ratio of about 1 part end-capped polyimide to about 3 to about 10 parts uncapped polyimide by weight. In this method, the ratio of end-capped polyimide to uncapped polyimide may further be at least about 1/10, or at least about ⅙, or at least about ⅕, and yet less than about ⅓, or less than about ⅕, or less than about ⅙.

The wear resistant polyimide may then be fabricated into a part by applying heat and pressure, as described, for example, in U.S. Pat. No. 4,360,626, op. cit.

Graphite is used as the component “(b)” of a composition hereof. Graphite is typically added to a polyimide composition to improve wear and frictional characteristics, and to control the coefficient of thermal expansion (CTE). The amount of graphite used in a polyimide composition for such purpose is thus sometimes advantageously chosen to match the CTE of the mating components.

Graphite is commercially available in a variety of forms as a fine powder, and may have a widely varying average particle size that is, however, frequently in the range of from about 5 to about 75 microns. In one embodiment, the average particle size is in the range of from about 5 to about 25 microns. In another embodiment, graphite as used herein contains less than about 0.15 weight percent of reactive impurities, such as those selected from the group consisting of ferric sulfide, barium sulfide, calcium sulfide, copper sulfide, barium oxide, calcium oxide, and copper oxide.

Graphite as suitable for use herein can be either naturally occurring graphite or synthetic graphite. Natural graphite generally has a wide range of impurity concentrations, while synthetically produced graphite is commercially available having low concentrations of reactive impurities. Graphite containing an unacceptably high concentration of impurities can be purified by any of a variety of known treatments including, for example, chemical treatment with a mineral acid. Treatment of impure graphite with sulfuric, nitric or hydrochloric acid, for example, at elevated or reflux temperatures can be used to reduce impurities to a desired level.

A carbon filament as used as the component “(c)” in a composition hereof is an elongated carbon structure that is relatively long in relation to its diameter, and a filament thus may have an aspect ratio (length divided by diameter) that is greater than about 10, or is greater than about 10², or is greater than about 10⁴, or is greater than about 10⁶, and yet is less than about 10⁹, or is less than about 10⁷, or is less than about 10⁵ or is less than about 10³.

The diameter referred to in the aspect ratio is the outside diameter of the filament since the filament may, in certain embodiments, be tubular in shape and thus also have an inside diameter that describes the size of a bore, such as an annular opening, in the interior of the filament. The bore may be devoid of carbon and/or may be empty or evacuable, or the bore may contain carbon bridges therein. The hollow bore may run along at least a portion of the length of the filament, or may run along essentially the entire length of the filament. In other embodiments, however, the filament does not to any significant extent have a bore or interior annular opening.

Although most carbon filaments are relatively regular in shape and nearly constant in diameter, a stated diameter value for a filament, whether inside or outside diameter, is nevertheless an average diameter value determined for a selected length of the filament. The outside diameter of a carbon filament as used herein may be greater than about 1 nm, or greater than about 5 nm, or greater than about 10 nm, or greater than about 100 nm, and yet be less than about 500 nm, or less than about 250 nm, or less than about 100 nm, or less than about 10 nm. For those carbon filaments that have a bore, the interior diameter of a filament as used herein may be greater than about 1 nm, or greater than about 5 nm, or greater than about 10 nm, or greater than about 50 nm, and yet be less than about 300 nm, or less than about 100 nm, or less than about 50 nm, or less than about 25 nm.

The cross section of a carbon filament may form a shape that is cylindrical, or essentially cylindrical, or a shape that is polyhedral. Filaments having an outside diameter in the smaller size ranges, such as about 1 nm to about 20 nm, or about 1 nm to about 10 nm, or about 1 nm to about 5 nm, have a shape that is nearly truly cylindrical and thus have a cross section that is nearly truly circular. A carbon filament can be continuous or non-continuous.

Carbon filaments suitable for use herein may be prepared by various known processes such as vapor deposition or laser ablation of a carbon target. Vapor grown filaments may be made by thermal decomposition of an organic compound, particularly a hydrocarbon gas, such as benzene, toluene, or xylene, in the presence of a transition metal catalyst. The filaments are obtained by the formation around a catalyst element of one or more graphene layers that may have a variety of different geometries and orientations to each other. Suitable catalysts include nickel and iron. When more than one graphene layer is present, they are often arranged in a regularly repeating pattern.

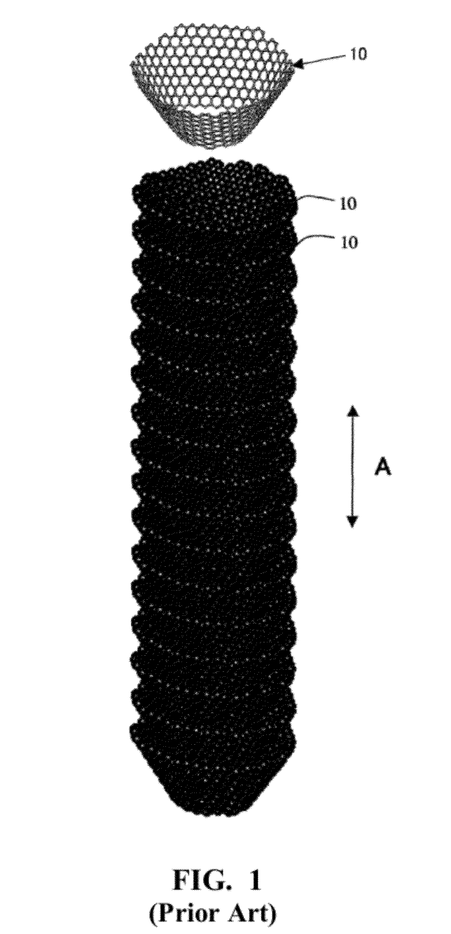

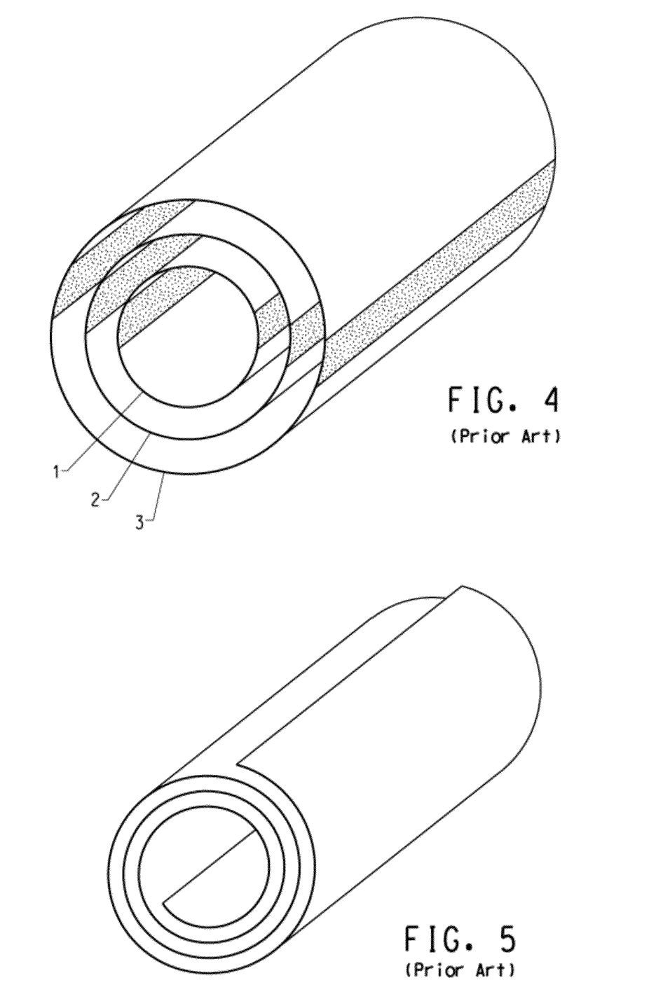

In a carbon filament as used herein the graphitic carbon atoms may have variety of arrangement including one or a combination of agglomerations, crystals, layers, concentric layers, differently-oriented layers, tree-like structures, or hollow structures. The graphene sheets, in what is known as an axial arrangement, may lie parallel to or essentially parallel to the axis of the filament, and when viewed in cross section, will appear to be circular or essentially circular. This type of arrangement is shown in FIGS. 4 and 5. In other embodiments, however, the graphene sheets may lie at an angle to the axis and thus flare out from the axis of the filment in an orientation referred to as angled. The graphene sheets in this arrangement appear to form stacked cups or inverted lampshades, and this is shown in FIGS. 1 to 3.

The carbon filaments suitable for use herein include those structures that are sometimes referred to as carbon fibrils, fine carbon fibers or carbon nanofibers, any one of which may actually be a bundle of individual filaments. Carbon structures such as those typically have an outside diameter in the range of about 50 nm to about 300 nm, or in the range of about 100 nm to about 250 nm. The carbon filaments suitable for use herein also include those structures that are sometimes referred to as carbon nanotubes, which may be single-wall nanotubes or multi-wall nanotubes. Single-wall carbon nanotubes typically have an outside diameter in the range of about 1 nm to about 5 nm; and multi-wall carbon nanotubes typically have an outside diameter in the range of about 2 nm to about 100 nm, or about 5 nm to about 10 nm, depending on the number of walls.

In one embodiment, the carbon filament used herein can have an average diameter of about 70 to about 400 nm, an average length of about 5 to about 100 μm, and/or an aspect ratio (i.e., length over diameter) of at least about 50.

Also suitable for use herein are mixtures of different kinds of carbon filaments wherein the various components of the mixture may differ as to diameter, aspect ratio, shape, extent of layering of graphene sheets, arrangement of graphene sheets, presence or absence of a closed end on the tube formed from a “rolled-up” graphene sheet, and presence or absence of defects and contaminants. Typical defects are graphene edges, which is the edge of a hexagonal ring in a graphene sheet that protrudes from the structure formed from the sheet because the ring is not bonded along that edge to an adjacent ring; and the presence in a graphene sheet of pentagonal or heptagonal carbon rings rather than the preferred hexagonal rings. Defect sites are not desired since the filament at that location is more susceptible to thermal oxidation. Typical contaminants are catalyst residue from the manufacturing operation (e.g. iron particles), extraneous, unwanted products obtained from the manufacturing operation (e.g. amorphous carbon), or contaminants (e.g. “dissolved” iron).

In a preferred embodiment, a carbon filament as used herein will have only traces (less than about 10, less that about 5, less than about 1, less than about 0.5, or less than about 0.1 parts per hundred) of other elements such as boron, silicon, iron or hydrogen. Preferably, the filaments used herein, and compositions containing them, will have less than 0.5 weight percent of reactive impurities such as ferric sulfide, barium sulfide, calcium sulfide, copper sulfide, barium oxide, calcium oxide, or copper oxide, or compounds of the elements barium, copper, calcium, or the elements iron, barium, copper or calcium.

In the case of iron, it is preferred to have less than about 0.02 wt % of the element present in the carbon fiber. However, when iron is present at any level it is desirable that the iron be encapsulated by the carbon, or protected due to the carbon layers around the iron particles. In such case, the iron that is present in the filament is not accessible for oxidation. For example, carbon filament mixtures CF-A or CF-B, as described herein, are preferred to the extent that the iron impurities therein are less extensive and less reactive than is the case with carbon filament mixtures CF-CN or CF-CP. Impurity content may be determined by visual inspection of a transmission electron micrograph (“TEM”) of a sample of a carbon filament, and by calculation of impurity content in terms of the number count of observed impurities in relation to the size of the sample evaluated.

Defect density (i.e. defect content) may also be determined by visual inspection of a TEM of a sample of a carbon filament, and by calculation of the defect density in terms of the number count of observed defect sites in relation to the size of the sample evaluated. If desired, different kinds of defects can be given different weightings in the calculation of overall defect density. For example, an edge site might be weighted twice as undesirable as a pentagonal site, and thrice as undesirable as a heptagonal site. Different weighting can be given to defect sites located on the surface of a filament as compared to an interior site, or to a defect site located on an axial graphene sheet as compared to a angled (cup-in-cup or lampshade) graphene sheet. Defect density may be in the range of 1 defect in about 50 to about 100 nanometers of filament length, preferably 1 defect in about 100 to about 200 nanometers of filament length, and more preferably 1 defect in about 250 to about 1000 nanometers of filament length.

Various carbon filaments that are suitable for use in a composition hereof include the following:

(i) a vapor grown fine carbon fiber including a hollow space along the fiber in its interior, and having a multi-layer structure, an outer diameter of 2 to 500 nm, and an aspect ratio of 10 to 15,000, which is further described in U.S. Pat. No. 6,730,398, which is by this reference incorporated in its entirety as a part hereof for all purposes;

(ii) isolated graphitic polyhedral crystals comprising graphite sheets arranged in a plurality of layers to form an elongated structure having a long axis and a diameter and having 7 or more external facets running substantially the length of the long axis, wherein the diameter is from 5 nm to 1000 nm and the external facets are of substantially equal size, and wherein the crystal may be in the form of a rings, cones, double tipped pyramids, nanorods and whiskers, which is further described in U.S. Pat. No. 6,740,403, which is by this reference incorporated in its entirety as a part hereof for all purposes;

(iii) a fine carbon fiber, the main body of each fiber filament of the fiber having an outer diameter of about 1 to about 500 nm and an aspect ratio of about 10 to about 15,000 and comprising a hollow space extending along its center axis and a multi-layer sheath structure consisting of a plurality of carbon layers, the layers forming concentric rings, wherein the fiber filament has a nodular portion which is formed of outwardly protruding carbon layers or formed of a locally increased number of carbon layers; and a similar fine carbon fiber, in which the fiber filament has repeatedly enlarged protruding portions and the filament diameter varies along with the length of the filament, the ratio of the diameter (d″) of a fiber filament of the fiber as measured at the outwardly enlarged portions to the diameter (d) of a fiber filament of the fiber as measured at a position at which no outwardly enlarged portions is present; i.e., d″/d, being about 1.05 to about 3; both of which are further described in U.S. Pat. No. 6,844,061, which is by this reference incorporated in its entirety as a part hereof for all purposes;

(iv) a fine carbon fiber mixture produced through a vapor-growth process, which comprises fine carbon fiber, each fiber filament of the fiber having an outer diameter of 1 to 500 nm and an aspect ratio of 10 to 15,000 and comprising a hollow space extending along its center axis and a multi-layer sheath structure consisting of a plurality of carbon layers, which is further described in U.S. Pat. No. 6,974,627, which is by this reference incorporated in its entirety as a part hereof for all purposes;

(v) VGCF® carbon filament (a product of Showa Denko K.K.), average fiber diameter: 150 nm, average fiber length: 9 μm, aspect ratio:60, BET specific surface area:13 m²/g, d₀₀₂=0.339 nm, and Id/Ig=0.2; and VGCF-S (average fiber diameter:100 nm, average fiber length:13 μm, aspect ratio:130, BET specific surface area:20 m²/g, d₀₀₂=0.340 nm, and Id/Ig=0.14), which is further described in U.S. Pat. No. 7,569,161, which is by this reference incorporated in its entirety as a part hereof for all purposes;

(vi) multiwall axial carbon filaments can have two or more concentric adjacent graphene tubes or have a scrolled, or rolled-up, type structure, wherein the carbon nanotubes comprise one or more graphite layers, wherein the graphite layers are composed of two or more graphene layers arranged one on top of the other, and the graphite layers form a rolled-up structure, wherein the carbon nanotubes, in cross-section, exhibit a spiral arrangement of the graphite layers, and wherein the carbon nanotubes exhibit a mean diameter of from 3 to 100 nm, which is further described in U.S. Patent Publication 2009/0124705, which is by this reference incorporated in its entirety as a part hereof for all purposes; and

(vii) scrolls and nested tubes that co-exit within a single multiwall carbon nanotube where, in scrolled structures, the layers are oriented essentially parallel to the length axis A, and form an angle with the axis that is typically 0 degrees, or less than at least one of less than 20 degrees, 10 degrees, or 5 degrees; or the length dimension of the tubes or scrolls parallel to the A axis is at least one of 5, 10, 20, 40, 80, 160, or 300 times longer than the outside diameter perpendicular to the A axis, which are further described in S. Iijima, Nature, 354 (1991) 56-58; and “Scrolls and nested tubes in multiwall carbon nanotubes” by J. Gerard Lavina, Shekhar Subramoney, Rodney S. Ruoff, Savas Berber, and David Tománek in Carbon 40 (2002) 1123-1130.

Other carbon filaments that are suitable for use in a composition hereof include those shown in various figures of this specification, which may be further described as follows:

FIG. 1: a lampshade graphene structure 10, and a stack of many such layers over a length A. The lampshade graphene structure 10 can also be referred to as a bottomless cup. In FIG. 1A the angle of the surface of lampshade graphene structure 10 perpendicular to the length A illustrates an aspect of the orientations of graphene layers in a carbon filament.

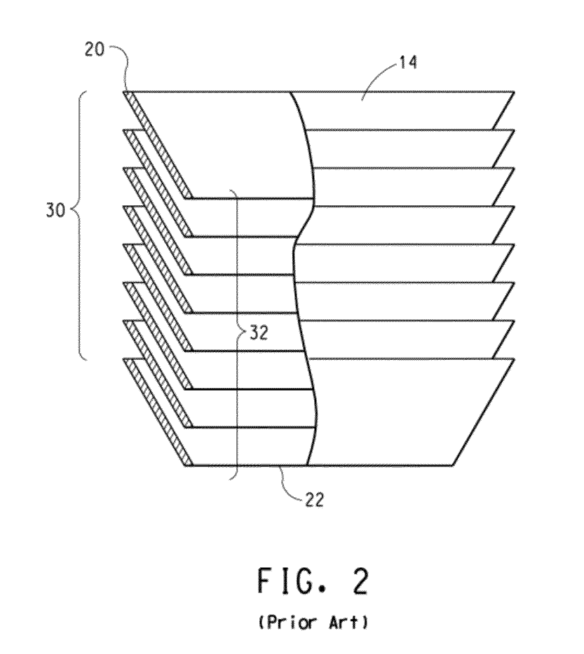

FIG. 2: a stack 14 of eight lampshade graphene structures in partial cutaway. The cutaway portion of a lampshade graphene structure 20 illustrates an angle of about 45 degrees to the length vector A of the stack.

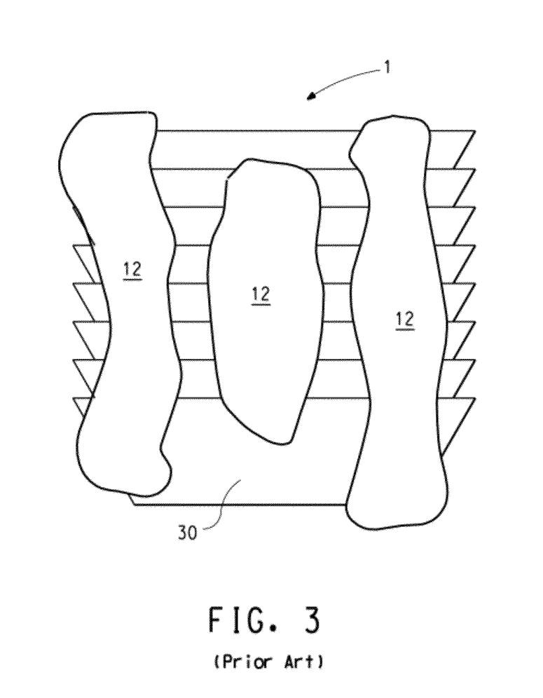

FIG. 3: a portion of a filament 1 having an inner portion 30 of stacked lampshade graphene structure and outer portions 12 of carbonaceous material, such as amorphous carbon.

FIG. 4: a portion of a multiwall axial carbon filament with 3 concentric graphene tubes. Multiwall axial carbon filaments have two or more concentric adjacent graphene tubes (or scrolls) oriented essentially parallel to the length of axis A, where essentially parallel is typically 0 degrees, or less than at least one of less than 20 degrees, less than 10 degrees, or less than 5 degrees in the angel formed with the axis. A parallel orientation may also exist where the length dimension of the tubes or scrolls parallel to the A axis is at least one of 5, 10, 20, 40, 80, 160 or 300 times longer than the outside diameter perpendicular to the A axis.

FIG. 5: a lengthwise cutaway of a multiwall axial carbon filament formed of a single spiraled graphene sheet, which is described as having more than two and less than five layers.

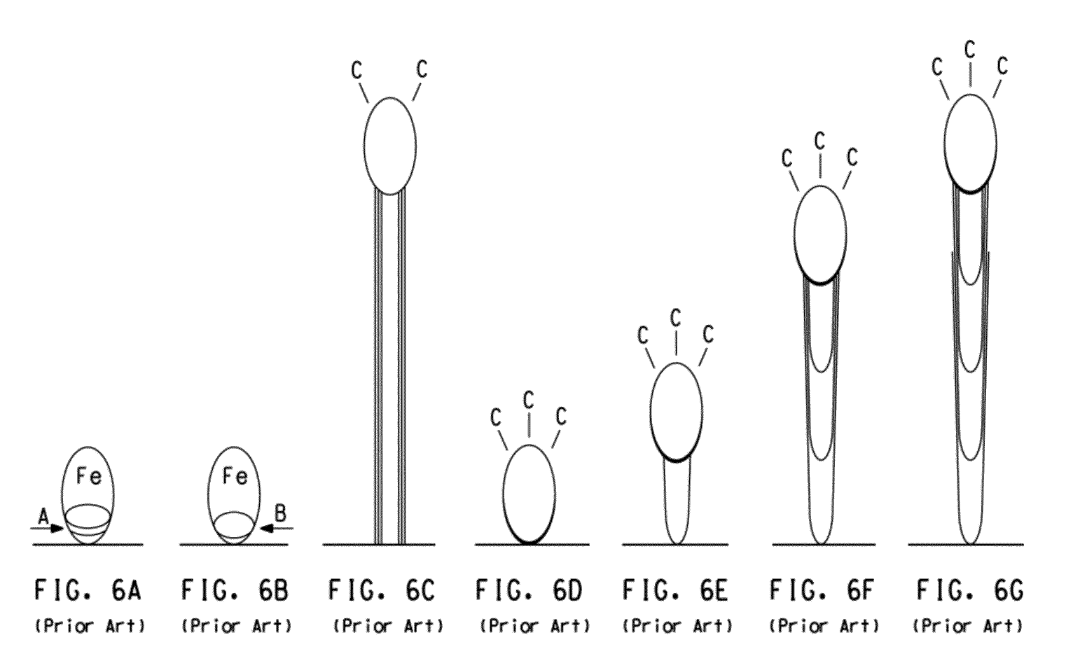

FIG. 6: an iron (Fe) catalyst (a) or (b), produces a short multiwall axial carbon filament (c), or a single-wall capped carbon filament (e), capped on one end by graphene and one end by catalyst (d), or a multiwall carbon filament having axial multiwall and perpendicular (90 degree) single wall graphene (f), (g), commonly called “bamboo-like” multiwall carbon filament.

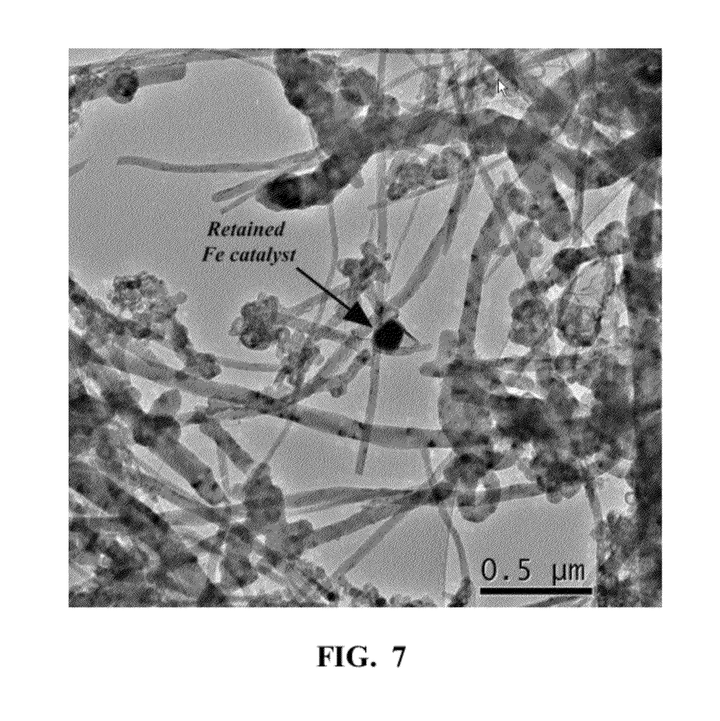

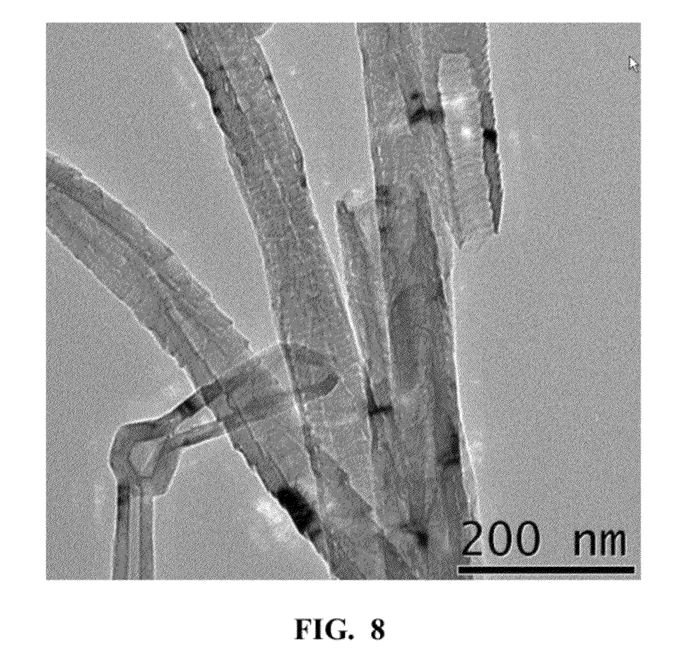

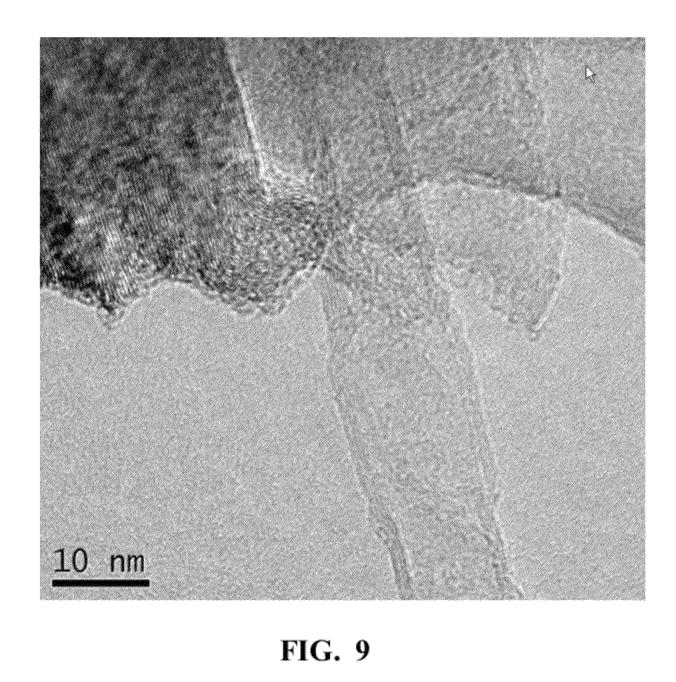

FIG. 7: mixture CF-CN, which was obtained from Nanostructured & Amorphous Materials Inc. (NanoAmor) (Houston, Tex.). Iron content of the sample was about 73 ppm as determined by the manufacturer. The filaments in the sample CF-CN were a graphitized carbon nanofiber about 80-200 nm in diameter and 10-40 microns long. A bore is present through most of the fibers, giving the multilayer graphene portion of the fiber an inner diameter about 50% of the filament outer diameter. Many of the filaments have a bamboo-like structure, but very few have a multilayer lampshade stacking portion.

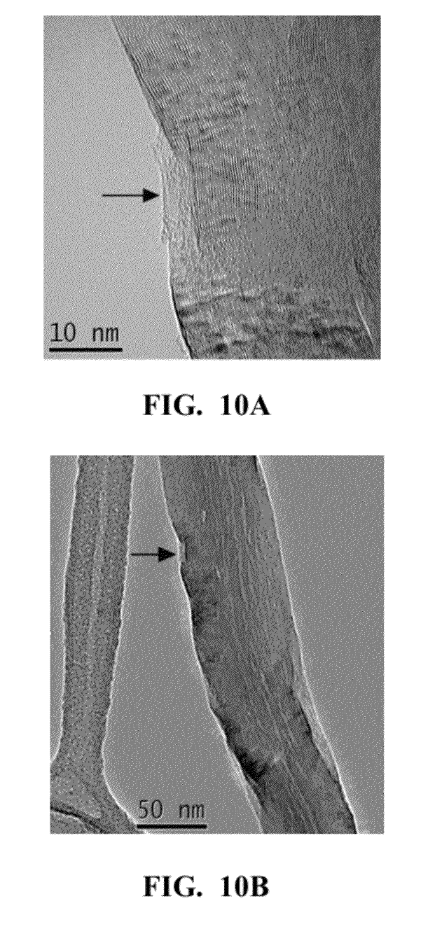

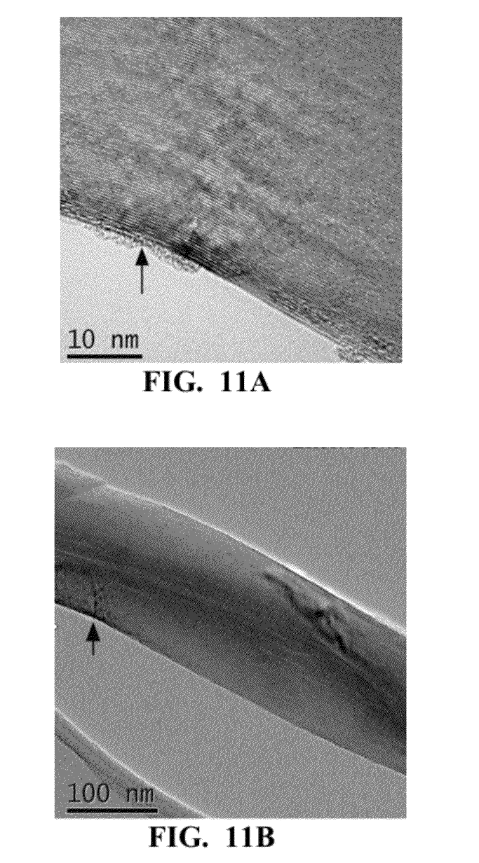

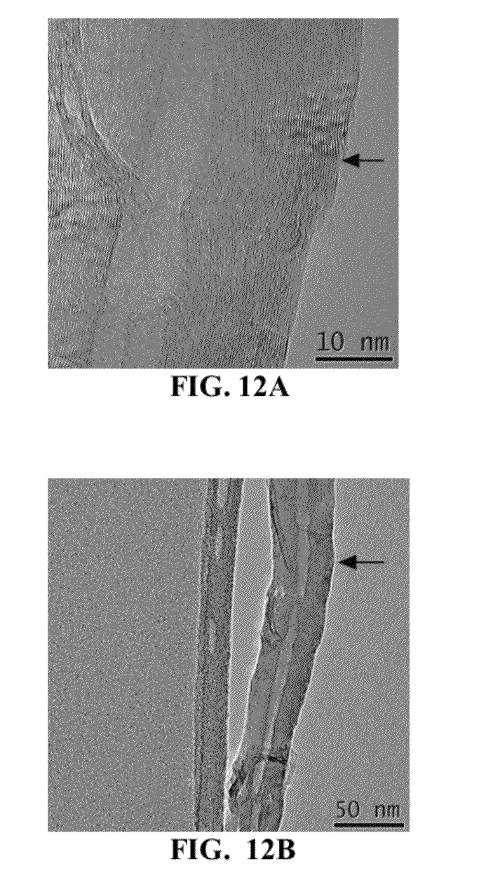

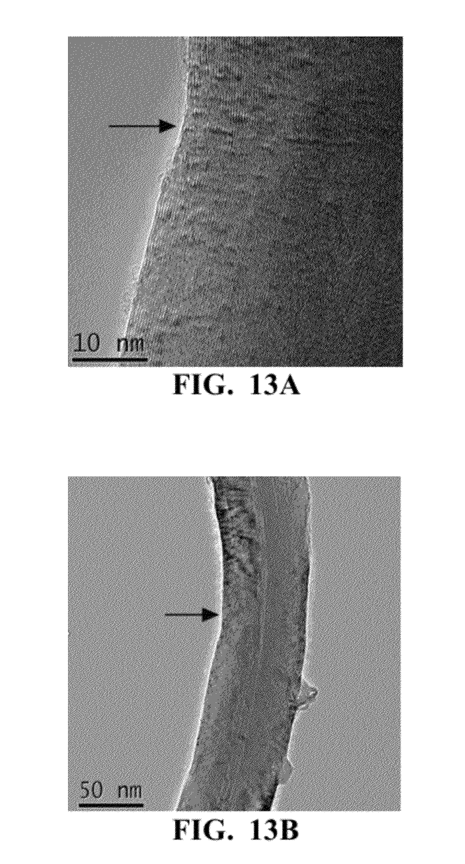

FIGS. 10A and 10B: mixture CF-A, a multiwall axial carbon filament, where mixture CF-A was obtained from Showa Denko K. K. (Tokyo). The sample density is approximately 2.1 g/cm3. The sample was reported to have a surface area of approximately 13 (m²/g). Iron content was found to be about 13 ppm by inductively coupled plasma analysis. The isothermal aging test below showed a weight loss of 0.882% for the sample. Filaments of CF-A were predominantly (>50%) a multiwall carbon nanotube typically about 150 nm in diameter, with less than about 10% having a diameter greater than 170 nm, and nearly all less than 350 nm. The average filament length was about 10-20 microns. Each fiber had a narrow observable hollow bore of about 10 nm, or no observable bore, and the bore if present apparently extended through one narrow end but not both of the fiber (one end appeared capped and the other uncapped). The fiber was unbranched. The sample contained polyhedral carbon particles with aspect ratio about 1 and length about 100-300 nm. Less than about 10% of filaments were lampshade graphene or bamboo-like graphene.

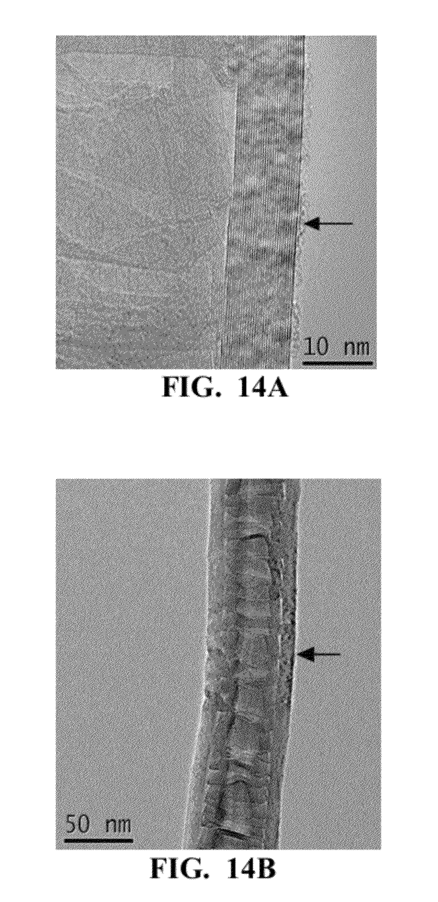

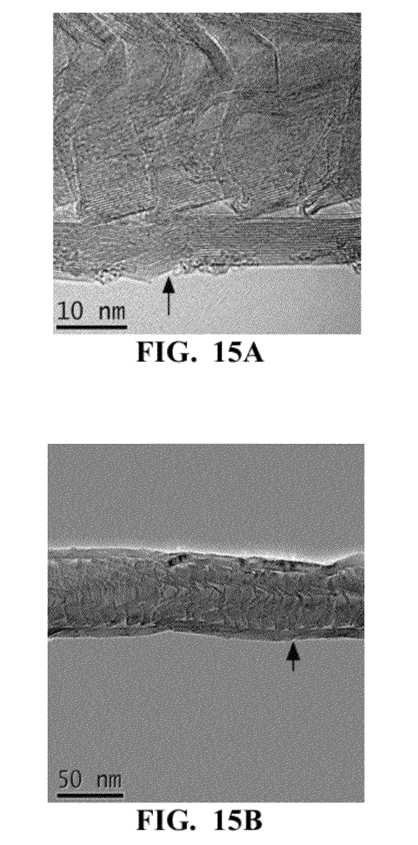

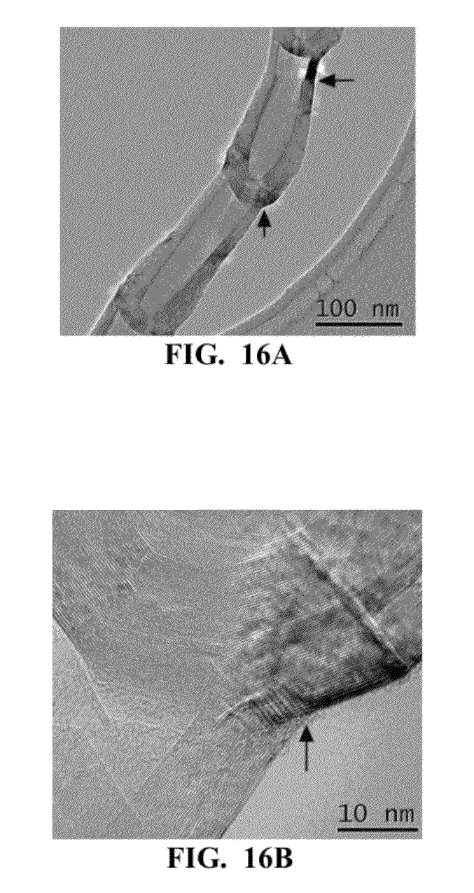

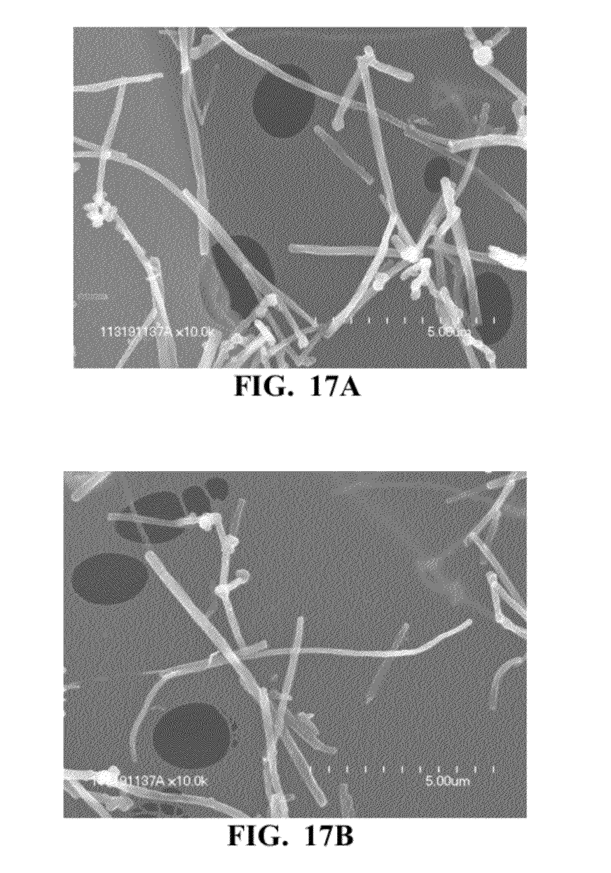

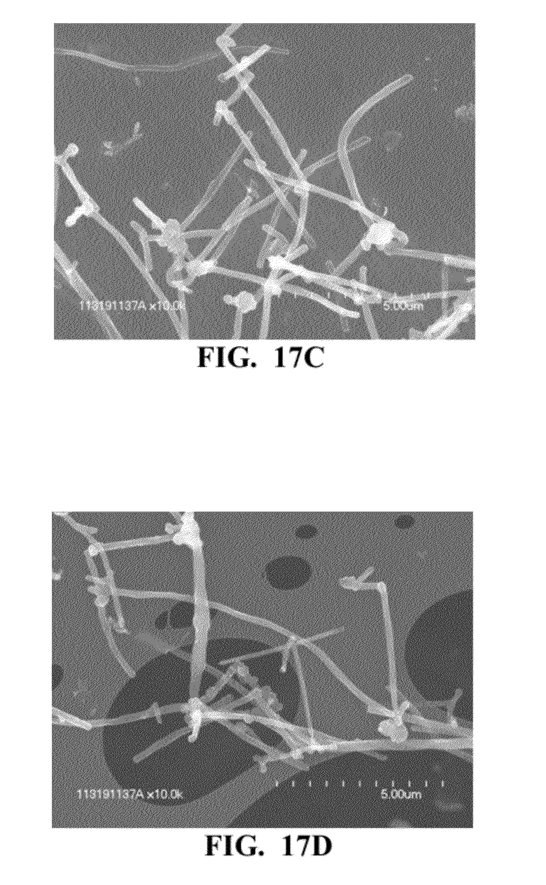

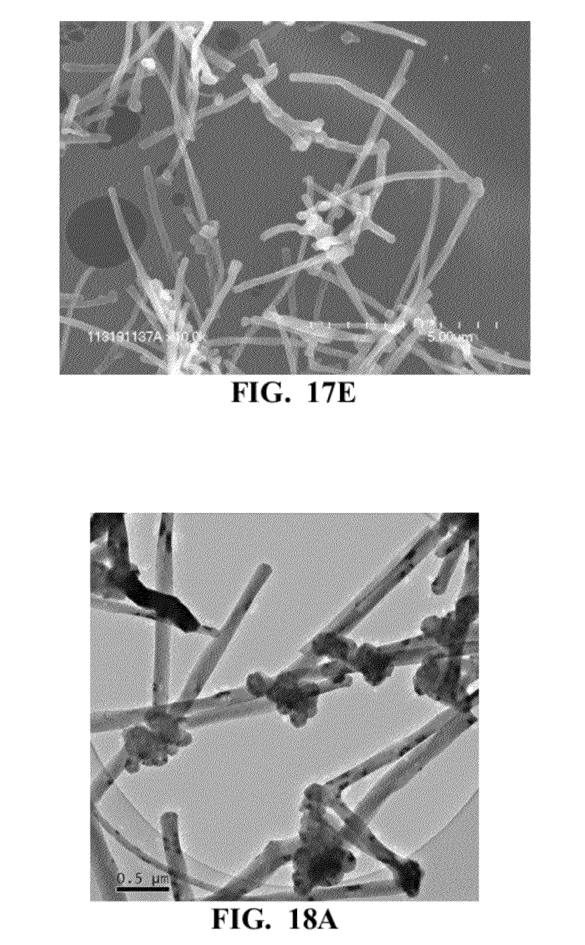

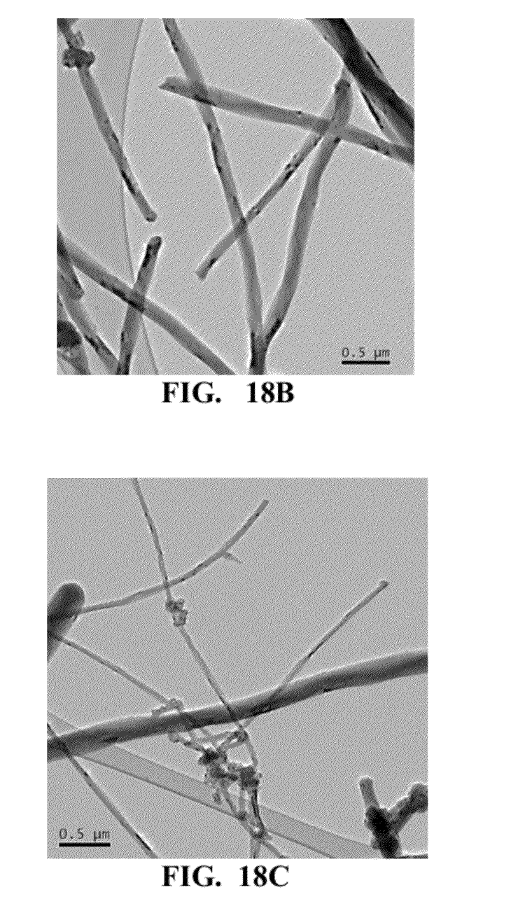

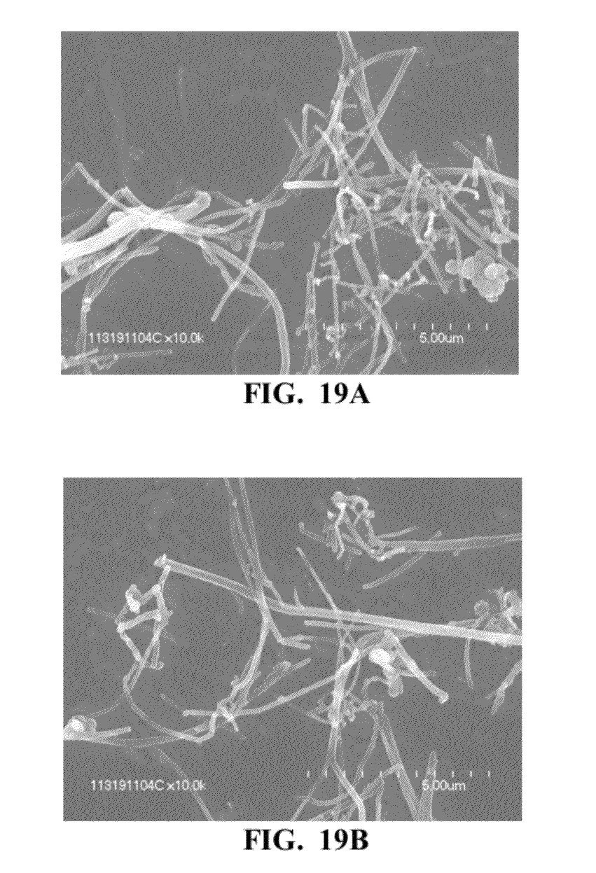

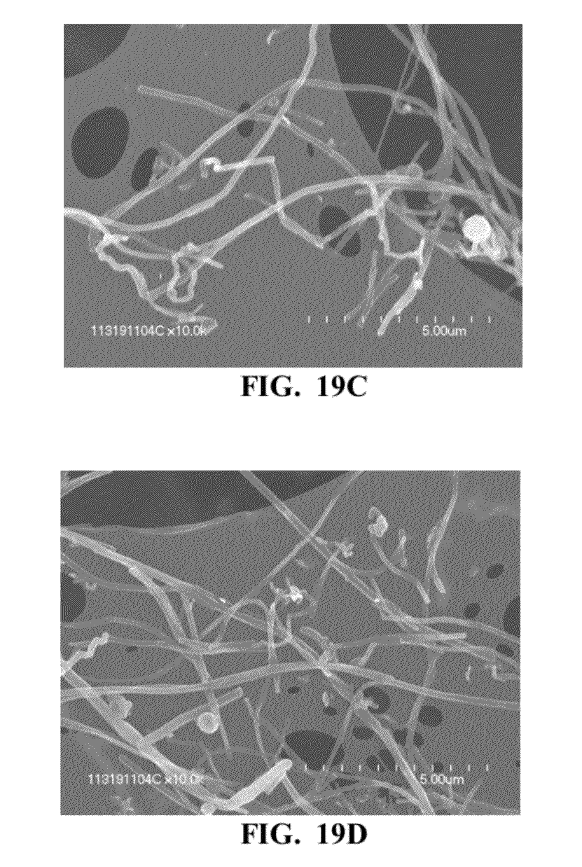

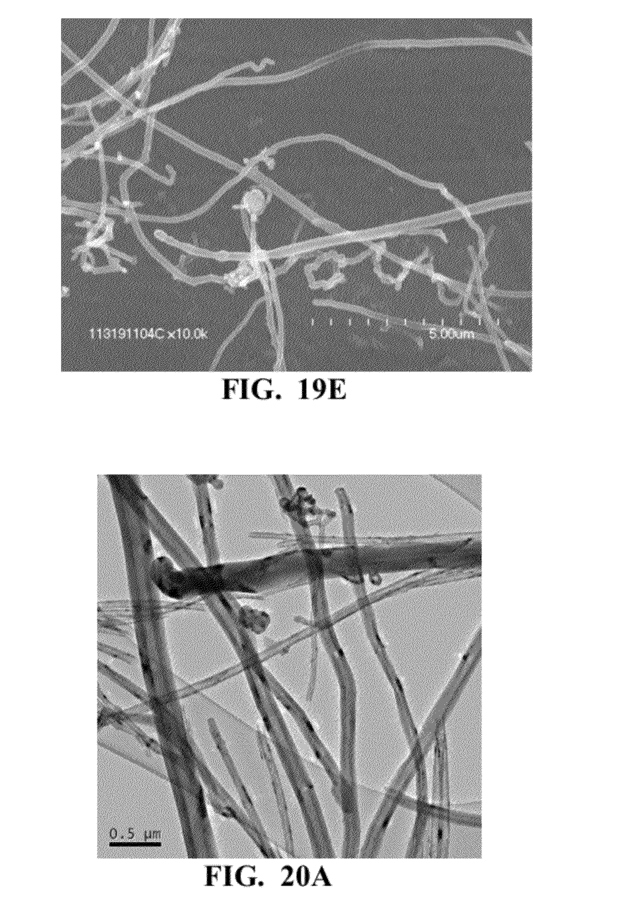

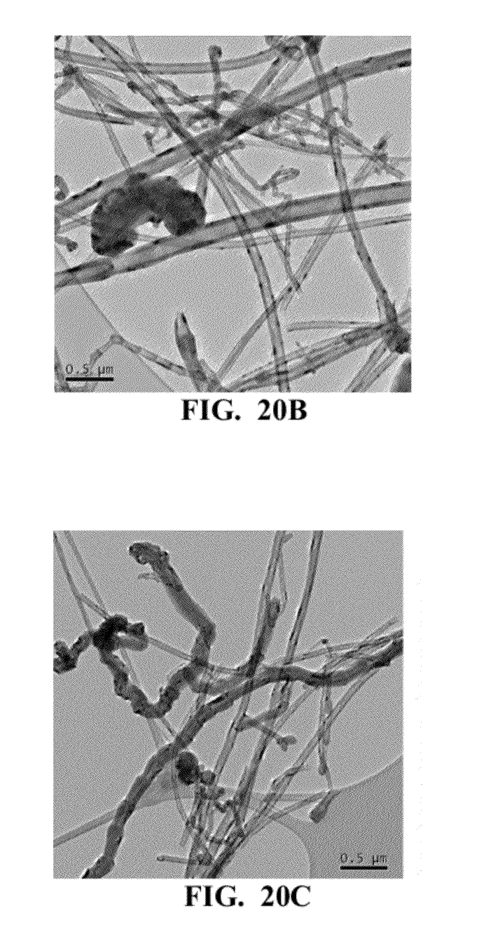

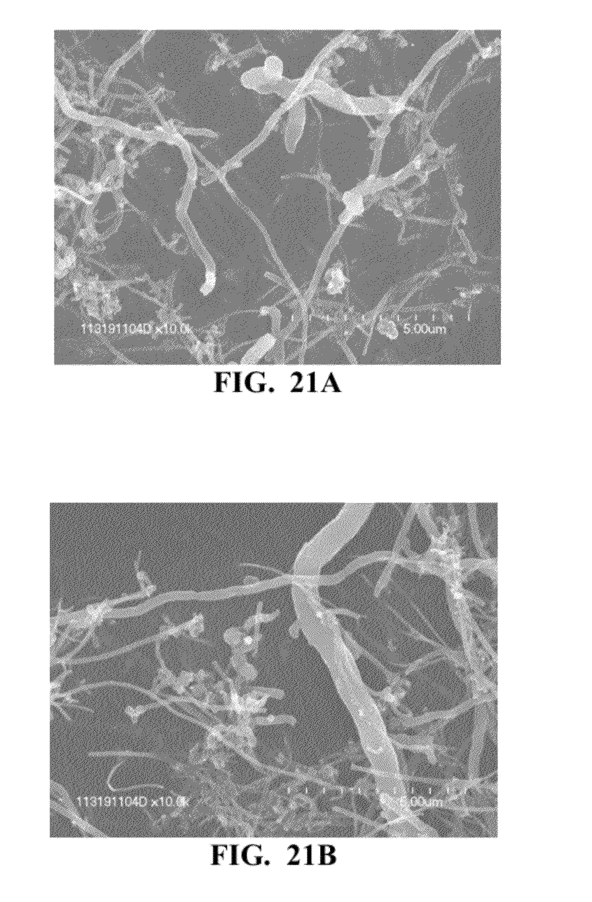

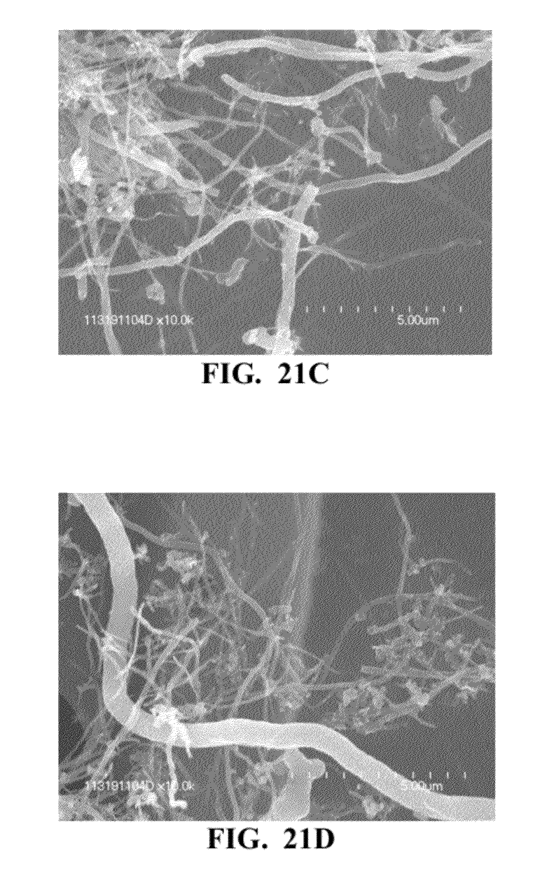

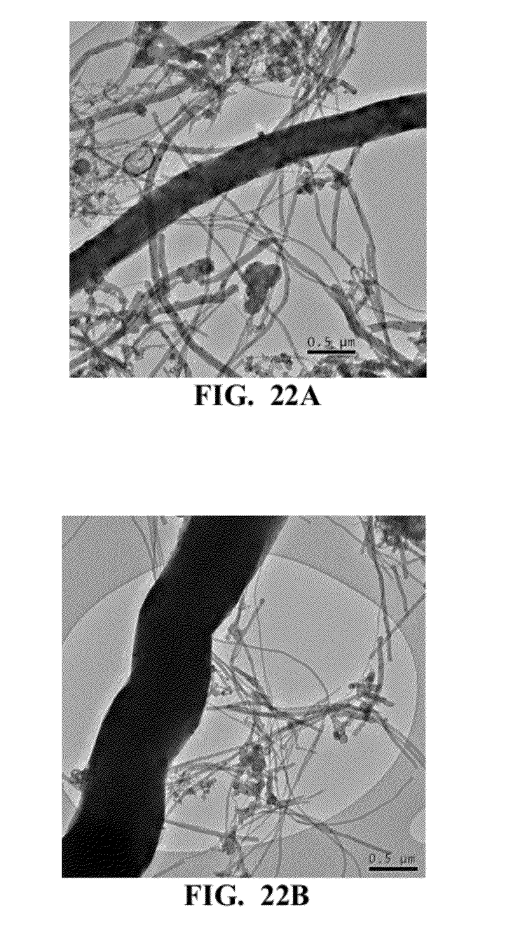

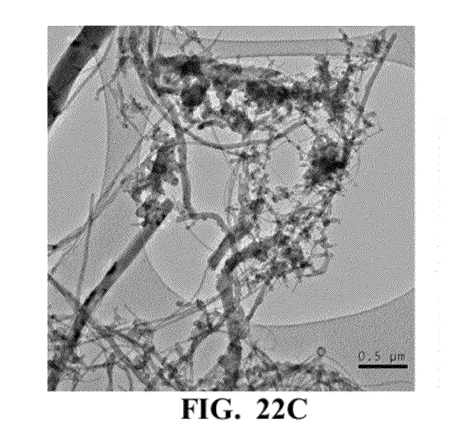

FIGS. 14A and 14B: mixture CF-CP, which was obtained from was obtained from Pyrograf Products Inc (Cedarville Ohio). Iron content of the sample was about 168 ppm as determined by the manufacturer. The isothermal aging test below showed a weight loss of 2.082% for the sample. The filaments were predominantly (>50%) a graphitized carbon nanofiber with diameter of 100 to 200 (˜150) nm, length of 30 to 100 microns, with a surface area of 15-25 (m²/g). Most filaments had an obvious stacked lampshade morphology, often within a multilayer axial outer sheath.

Some of these carbon filaments are commercially available, such as VGCF®, VGCF®-H, VGCF®-S, and VGCF®-X vapor grown carbon filaments from Showa Denko, KK (Tokyo, Japan); and Pyrograf® III carbon nanofibers from Pyrograf Products, Inc. (Cedarville, Ohio).

The graphite, component (b), and carbon filaments, component (c), as used in the compositions and articles hereof, are frequently incorporated into the heated solvent prior to transfer of the PAA polymer solution (or other solution for other types of monomers) as described above, so that the resulting polyimide is precipitated in the presence of the components (b) and (c), which thereby become incorporated into the composition.

In the compositions of this invention, the content of the various components includes all of the possible ranges that may be formed from the following amounts:
component (a), a rigid aromatic polyimide, end-capped with phthalic anhydride or a derivative of phthalic anhydride, may be present in an amount of about 40 weight parts or more, or about 42 weight parts or more, or about 44 weight parts or more, or about 46 weight parts or more, and yet in an amount of about 92 weight parts or less, or about 85 weight parts or less, or about 70 weight parts or less, or about 55 weight parts or less, or about 50 weight parts or less;
component (b), a graphite, may be present in an amount of about 8 weight parts or more, or about 15 weight parts or more, or about 30 weight parts or more, or about 45 weight parts or more, or about 50 weight parts or more, or about 52 weight parts or more, and yet in an amount of about 60 weight parts or less, or about 58 weight parts or less, or about 56 weight parts or less, or about 54 weight parts or less; and
component (c), carbon filament, may be present in an amount of about 0.5 weight parts or more, or about 1.0 weight parts or more, or about 2.0 weight parts or more, or about 3.0 weight parts or more, or about 4.0 weight parts or more, or about 5.0 weight parts or more, and yet in an amount of about 10.0 weight parts or less, or about 9.0 weight parts or less, or about 8.0 weight parts or less, or about 7.0 weight parts or less, or about 6.0 weight parts or less.

In a composition hereof, the amounts of the respective weight parts of the three components as combined together in any particular formulation, taken from the ranges as set forth above, may but need not total to 100 weight parts.

The compositions of this invention include all of the formulations in which the compositional content may be expressed by any combination of the various maxima and minima, as set forth above, for any one component of the composition together with any such combination of maxima and minima for either or both of the other two components.

One or more additives may be used as an optional component “(d)” of a composition hereof. When used, additive(s) may be used in an amount in the range of about 5 to about 70 wt % based on the total weight of all four components together in a 4-component [(a)+(b)+(c)+(d)] composition, with the total weight of three components together in a 3-component [(a)+(b)+(c)] composition being in the range of about 30 to about 95 wt % based on the total weight of all four components together in a 4-component [(a)+(b)+(c)+(d)] composition.

Additives suitable for optional use in a composition hereof may include, without limitation, one or more of the following: pigments; antioxidants; materials to impart a lowered coefficient of thermal expansion, e.g. carbon fibers; materials to impart high strength properties e.g. glass fibers, ceramic fibers, boron fibers, glass beads, whiskers, graphite whiskers or diamond powders; materials to impart heat dissipation or heat resistance properties, e.g. aramid fibers, metal fibers, ceramic fibers, whiskers, silica, silicon carbide, silicon oxide, alumina, magnesium powder or titanium powder; materials to impart corona resistance, e.g. natural mica, synthetic mica or alumina; materials to impart electric conductivity, e.g. carbon black, silver powder, copper powder, aluminum powder or nickel powder; materials to further reduce wear or coefficient of friction, e.g. boron nitride or poly(tetrafluoroethylene) homopolymer and copolymers. Fillers may be added as dry powders to the final resin prior to parts fabrication.

Materials suitable for use in or to make a composition hereof may themselves be made by processes known in the art, or are available commercially from suppliers such as Alfa Aesar (Ward Hill, Mass.), City Chemical (West Haven, Conn.), Fisher Scientific (Fairlawn, N.J.), Sigma-Aldrich (St. Louis, Mo.) or Stanford Materials (Aliso Viejo, Calif.).

As with products made from other infusible polymeric materials, parts fabricated from a composition hereof may be made by techniques involving the application of heat and pressure (see, for example, U.S. Pat. No. 4,360,626). Suitable conditions may include, for example, pressures in the range of from about from 50,000 to 100,000 psi (345 to 690 MPa) at ambient temperatures. Physical properties of articles molded from a composition hereof can be further improved by sintering, which may typically be performed at a temperature in the range of from about 300° C. to about 450° C.

Parts and other articles prepared from a composition hereof exhibit improved wear properties over comparable compositions comprising polyimide that is not end-capped and are useful in, for example, aerospace, transportation, and materials handling and processing equipment applications. These parts include a bushing, seal ring, spring, valve seat, vane, washer, button, roller, clamp, washer, gasket, spline, wear strip, bumper, slide block, spool, poppet, valve plate, labyrinth seal or thrust plug.

Parts and other articles prepared from a composition hereof are useful in aerospace applications such as aircraft engine parts, such as bushings (e.g., variable stator vane bushings), bearings, washers (e.g., thrust washers), seal rings, gaskets, wear pads, splines, wear strips, bumpers, and slide blocks. These aerospace application parts may be used in all types of aircraft engines such as reciprocating piston engines and, particularly, jet engines. Other examples of aerospace applications include without limitation: turbochargers; shrouds, aircraft subsystems such as thrust reversers, nacelles, flaps systems and valves, and aircraft fasteners; airplane spline couplings used to drive generators, hydraulic pumps, and other equipment; tube clamps for an aircraft engine to attach hydraulic, hot air, and/or electrical lines on the engine housing; control linkage components, door mechanisms, and rocket and satellite components.

Parts and other articles prepared from a composition hereof are also useful in transportation applications, for example, as components in vehicles such as but not limited to automobiles, recreational vehicles, off-road vehicles, military vehicles, commercial vehicles, farm and construction equipment and trucks. Examples of vehicular components include without limitation: automotive and other types of internal combustion engines; other vehicular subsystems such as exhaust gas recycle systems and clutch systems; fuel systems (e.g., bushings, seal rings, band springs, valve seats);pumps (e.g., vacuum pump vanes); transmission components (e.g., thrust washers, valve seats, and seal rings such as seal rings in a continuously variable transmission), transaxle components, drive-train components, non-aircraft jet engines; engine belt tensioners; rubbing blocks in ignition distributors; powertrain applications (e.g., emission components, variable valve systems, turbochargers (e.g., ball bearing retainers, wastegate bushings), air induction modules); driveline applications (e.g., seal rings, thrust washers and fork pads in manual and dual clutch transmissions, transfer cases); seal rings and thrust washers for heavy-duty off-road transmissions and hydraulic motors; bushings, buttons, and rollers for continuous variable transmissions in all-terrain vehicles (“ATVs”) and snowmobiles; and chain tensioners for snowmobile gear cases; brake systems (e.g., wear pads, valve components for anti-lock braking systems); door hinge bushings; gear stick rollers; wheel disc nuts, steering systems, air conditioning systems; suspension systems; intake and exhaust systems; piston rings; and shock absorbers.

Parts and other articles prepared from a composition hereof are also useful in material handling equipment and materials processing equipment, such as injection molding machines and extrusion equipment (e.g., insulators, seals, bushings and bearings for plastic injection molding and extrusion equipment), conveyors, belt presses and tenter frames; and films, seals, washers, bearings, bushings, gaskets, wear pads, seal rings, slide blocks and push pins, glass handling parts such as clamps and pads, seals in aluminum casting machines, valves (e.g., valve seats, spools), gas compressors (e.g., piston rings, poppets, valve plates, labyrinth seals), hydraulic turbines, metering devices, electric motors (e.g., bushings, washers, thrust plugs), small-motor bushings and bearings for handheld tools appliance motors and fans, torch insulators, and other applications where low wear is desirable.

Parts and other articles prepared from a composition hereof are also useful in the manufacture of beverage cans, for example, bushings in body makers that form the can shape, vacuum manifold parts, and shell press bands and plugs; in the steel and aluminum rolling mill industry as bushings and mandrel liners; in gas and oil exploration and refining equipment; and in textile machinery (e.g., bushings for weaving machines, ball cups for knitting looms, wear strips for textile finishing machines).

In some applications, a part or other article prepared from a composition hereof is in contact with metal at least part of the time when the apparatus in which it resides is assembled and in normal use.

### EXAMPLES

The advantageous attributes and effects of the compositions hereof may be seen in the example (Example 1), as described below. The embodiment of the composition on which the example is based is representative only, and the selection of that embodiment to illustrate the invention does not indicate that materials, components, reactants, ingredients, formulations or specifications not described in this example are not suitable for practicing the inventions herein, or that subject matter not described in this example is excluded from the scope of the appended claims and equivalents thereof. The significance of the example is better understood by comparing the results obtained therefrom with the results obtained from certain trial runs that are designed to serve as controlled experiments (Comparative Examples A˜C) and provide a basis for such comparison since the compositions therein do not contain the combination of end-capped polyimide and vapor grown carbon filament.

In the examples, the following abbreviations are used: “BPDA” is defined as 3,3′,4,4′-biphenyltetracarboxylic anhydride, “cm” is defined as centimeter(s), “g” is defined as gram(s), “in” is defined as inch, “mmol” is defined as millimole(s), “MPa” is defined as megapascal(s), “MPD” is defined as m-phenylenediamine, “nm” is defined as nanometer(s), “μm” is defined as micrometer(s), “PPD” is defined as p-phenylenediamine, “psi” is defined as pounds per square inch, “PA” is defined as phthalic anhydride, “TOS” is defined as thermal oxidative stability, and “wt %” is defined as weight percent(age).

### Materials.

3,3′,4,4′-biphenyltetracarboxylic anhydride was obtained from Mitsubishi Gas Chemical Co., Inc. (Tokyo, Japan). M-phenylenediamine and p-phenylenediamine were obtained from DuPont (Wilmington, Del., USA). The graphite used was a synthetic graphite, maximum 0.05% ash, with a median particle size of about 8 μm. Phthalic anhydride (at least 99% purity) was obtained from Sigma-Aldrich (St. Louis, Mo., USA).

A sample of carbon filament (sample CF-A) was contained from Showa Denko K. K. (Tokyo). The sample density is reported as approximately 2.1 g/cm³. The sample was reported to have a surface area of approximately 13 (m²/g). Iron content was found to be about 13 ppm by inductively coupled plasma analysis. The isothermal aging test below showed a weight loss of 0.882% for the sample.

Filaments of CF-A were predominantly (>50%) a multiwall carbon nanotube typically about 150 nm in diameter, with apparently less than 10% having a diameter greater than 170 nm, and nearly all less than 350 nm. The average filament length was about 10-20 microns. Each fiber had a narrow observable hollow bore of about 10 nm, or no observable bore; and the bore, if present, apparently extended through one narrow end but not both of the fiber (one end appeared closed and the other open). The fiber was unbranched. The sample contained polyhedral carbon particles with aspect ratio about 1 and length about 100-300 nm. Less than about 10% of filaments were lampshade graphene or bamboo-like graphene as observed by microscopy.

### Methods.

Dried polyimide resin was fabricated into tensile bars for TOS measurements by direct forming according to ASTM E8 (2006), “Standard Tension Test Specimen for Powdered Metal Products-Flat Unmachined Tensile Test Bar”, at room temperature and 100,000 psi (690 MPa) forming pressure. The tensile bars were sintered at 405° C. for 3 hours with a nitrogen purge.

Dried polyimide resin was fabricated into wear test specimens, disks 2.5 cm in diameter and about 0.5 cm thick, by direct forming, using a procedure substantially according to the procedure described in US 4,360.626 (especially column 2, lines 54-60).

High temperature wear on the disks was measured using the test procedures described in ASTM G 133-05 (2005), “Standard Test Method for Linearly Reciprocating Ball-on-Flat Sliding Wear”, modified by using a temperature controlled oven, with acquisition of friction force data on a computer. In these tests, a steel ball bearing was rubbed against the surface of a test specimen at the designated temperature under a 2 pound load oscillating at 300 cycles/minute for a 3 hour period. At the end of the experiment, the volume of the resulting wear scar on the test specimen was measured by optical profilometry, from which the volume of the wear scar was determined. The volume of the wear scar is reported as a wear rate under the indicated test conditions.

### Example 1

### Preparation of a Polyimide Resin with 1% Phthalate Endcapping Containing 47 Weight % Graphite and 3 Weight % CF-A

Polyimide resin based on 3,3′,4,4′-biphenyltetracarboxylic dianhydride (BPDA), m-phenylene diamine (MPD) and p-phenylene diamine (PPD) was prepared according to the method described in U.S. Pat. No. 5,886,129, which is by this reference incorporated in its entirety as a part hereof for all purposes. Ingredients were 8.77 g (81.1 mmol) MPD, 20.47 g (189 mmol) PPD, 79.55 g (270 mmol) BPDA, and 0.40 g (2.70 mmol) phthalic anhydride (PA) as an end-capping agent. The mole ratio of PA to BPDA was 1:100. The BPDA and PA were added to a pyridine solution of the MPD and PPD. The polyamic acid solution produced was imidized in the presence of 41.92 g of graphite, and 2.68 g of CF-A, to produce a resin containing 46.9 wt % graphite and 3.0 wt % CF-A. The resulting polyimide resin was isolated, washed, and dried. After drying, the resin was ground through a 20 mesh screen using a Wiley mill to form a powder.

The dried polyimide resin was fabricated into test specimens, disks 2.5 cm in diameter and about 0.5 cm thick, as described above. The wear rate of the test specimens as determined by ASTM G133, as described above, is given in Table 1, reported as the wear scar volume in units of 10⁻⁸ in³ (10⁻⁷ cm³). Thermooxidative stability (TOS) was measured under 5 atmospheres of air (0.5 MPa) and weight loss after 25 hours at 800° F. (427° C.) is given in Table 1. This determination is an average of four resin batches (i.e., four disks were tested, each of which was from a different resin batch).

### Comparative Example A

### Preparation of an Unmodified Polyimide Containing 50 Weight % Graphite

This resin was prepared by the method of Example 1, except that neither phthalic anhydride nor CF-A was used in the preparation. The wear rate of the resulting resin as determined by ASTM G133, as described above, is given in the table. This determination is an average of five resin batches. The standard deviation is about 15%, as shown in Table 1, providing an indication of the statistical significance of the findings. The TOS of the resulting resin is given in Table 1 and is the average of fourteen resin batches.

### Comparative Example B

### Preparation of a Polyimide Resin with 1% Phthalate End-capping Containing 50 Weight % Graphite

This resin was prepared by the method of Example 1, except that CF-A was not used in the preparation. The wear rate of the resulting resin as determined by ASTM G133, as described above, is given in the table. The TOS of the resulting resin is given in Table 1 and is the average of five measurements on the same batch of resin.

### Comparative Example C

### Preparation of an Unmodified Polyimide Containing 47 Weight % Graphite and 3 Weight % CF-A

This resin was prepared by the method of Example 1, except that phthalic anhydride was not used in the preparation. The wear rate of the resulting resin as determined by ASTM G133, as described above, is given in the table. This determination is an average of five resin batches. The TOS of the resulting resin is given in Table 1 and is the average of ten resin batches.

The results shown in Table 1 demonstrate that 1% end-capping alone lowered (improved) wear rate as determined by ASTM G133 (as described above), but increased (hurt) TOS and adding 3 wt % CF-A without end-capping left wear rate and TOS essentially unchanged, while the combination of 3 wt % CF-A and end-capping lowered (improved) both wear rate and TOS.

TABLE 1

| | | Wear Rate at | TOS at 800° F. |
|---|---|---|---|
| | | 800° F. (427° C.) in | (427° C.) as |
| Sample | Description | 10⁻⁸ in³(10⁻⁷ cm³) | percent wt loss |
| Example 1 | PA end-capped, | 1851(3033) | 2.10 ± 0.23 |
| | 3 wt % CF-A | | |
| Comparative | Not end-capped, | 2354 ± 358 | 2.96 ± 0.77 |
| Example A | no CF-A | (3858 ± 5 87) | |
| Comparative | PA end-capped, | 1845(3023) | 5.97 ± 0.49 |
| Example B | no CF-A | | |
| Comparative | Not end-capped, | 2251(3688) | 2.92 ± 0.61 |
| Example C | 3 wt % CF-A | | |

Where a range of numerical values is recited herein, the range includes the endpoints thereof and all the individual integers and fractions within the range, and also includes each of the narrower ranges therein formed by all the various possible combinations of those endpoints and internal integers and fractions to form subgroups of the larger group of values within the stated range to the same extent as if each of those narrower ranges was explicitly recited. Where a range of numerical values is stated herein as being greater than a stated value, the range is nevertheless finite and is bounded on its upper end by a value that is operable within the context of the invention as described herein. Where a range of numerical values is stated herein as being less than a stated value, the range is nevertheless bounded on its lower end by a non-zero value.

In this specification, unless explicitly stated otherwise or indicated to the contrary by the context of usage, where an embodiment of the subject matter hereof is stated or described as comprising, including, containing, having, being composed of or being constituted by or of certain features or elements, one or more features or elements in addition to those explicitly stated or described may be present in the embodiment. An alternative embodiment of the subject matter hereof, however, may be stated or described as consisting essentially of certain features or elements, in which embodiment features or elements that would materially alter the principle of operation or the distinguishing characteristics of the embodiment are not present therein. A further alternative embodiment of the subject matter hereof may be stated or described as consisting of certain features or elements, in which embodiment, or in insubstantial variations thereof, only the features or elements specifically stated or described are present.

In this specification, unless explicitly stated otherwise or indicated to the contrary by the context of usage,
(a) amounts, sizes, ranges, formulations, parameters, and other quantities and characteristics recited herein, particularly when modified by the term “about”, may but need not be exact, and may also be approximate and/or larger or smaller (as desired) than stated, reflecting tolerances, conversion factors, rounding off, measurement error and the like, as well as the inclusion within a stated value of those values outside it that have, within the context of this invention, functional and/or operable equivalence to the stated value;
(b) all numerical quantities of parts, percentage or ratio are given as parts, percentage or ratio by weight;
(c) use of the indefinite article “a” or “an” with respect to a statement or description of the presence of an element or feature of this invention, does not limit the presence of the element or feature to one in number; and
(d) the words “include”, “includes” and “including” are to be read and interpreted as if they were followed by the phrase “without limitation” if in fact that is not the case.

All references to documents and publications of the United States Patent and Trademark Office included in this disclosure are hereby included by reference as if the entire document or publication appeared herein.

What is claimed is:

1. A composition comprising in admixture (a) about 40 weight parts or more and yet about 92 weight parts or less of a rigid polyimide that is end-capped with phthalic anhydride, or a derivative of phthalic anhydride, as represented by the structure of the following Formula (IV): 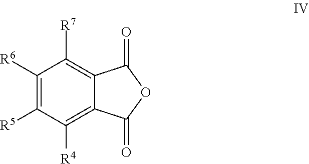
wherein R⁴, R⁵, R⁶, and R⁷ are each independently H, Br, Cl, F, alkyl, alkoxy, or fluoroalkyl; (b) about 8 weight parts or more and yet about 60 weight parts or less graphite; and (c) about 0.5 weight parts or more and yet about 10.0 weight parts or less of carbon filament.

2. A composition according to claim 1 wherein the carbon filament is vapor grown carbon fiber having a multilayered structure.

3. A composition according to claim 1 wherein the carbon filament has a hollow bore running along at least a portion of the length of the filament.

4. A composition according to claim 1 wherein the carbon filament contains less than about 150 ppm iron by weight.

5. A composition according to claim 1 wherein the carbon filament contains at least about 0.0005 mol boron per mole carbon.

6. A composition according to claim 1 wherein the carbon filament has one or more of the following properties: an average diameter of about 70 to about 400 nm, an average length of about 5 to about 100 μm, and an aspect ratio at least about 50.

7. A composition according to claim 1 wherein the polyimide is prepared from an aromatic tetracarboxylic acid compound or derivative thereof, wherein the aromatic tetracarboxylic acid compound is represented by the Formula (II): 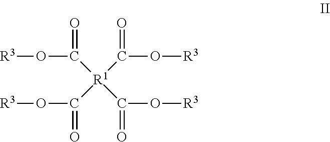
wherein R¹ is a tetravalent aromatic group, and each R³ is independently hydrogen or a C₁˜C₁₀ alkyl group, or mixtures thereof.

8. A composition according to claim 1 wherein the polyimide is prepared from an aromatic tetracarboxylic acid compound selected from the group consisting of 3,3′,4,4′-biphenyltetracarboxylic acid, 3,3′,4,4′-biphenyltetracarboxylic dianhydride, 2,3,3′,4′-biphenyltetracarboxylic acid, 2,3,3′,4′-biphenyltetracarboxylic dianhydride, pyromellitic acid, pyromellitic dianhydride, 3,3′,4,4′-benzophenonetetracarboxylic acid, 3,3′,4,4′-benzophenonetetracarboxylic dianhydride, 2,3,6,7-naphthalenetetracarboxylic acid, 1,4,5,8-naphthalenetetracarboxylic acid, 2,3,6,7-naphthalenetetracarboxylic dianhydride, 1,4,5,8-naphthalenetetracarboxylic dianhydride and mixtures thereof.

9. A composition according to claim 1 wherein the polyimide is prepared from a diamine compound represented by the structure H₂N—R²—NH₂, wherein R² is a divalent aromatic radical containing up to 16 carbon atoms and, optionally, containing in the aromatic ring one or more heteroatoms selected from the group consisting of —N—, —O—, and —S—.

10. A composition according to claim 1 wherein the polyimide is prepared from a diamine compound selected from the group consisting of 2,6-diaminopyridine, 3,5-diaminopyridine, 1,2-diaminobenzene, 1,3-diaminobenzene, 1,4-diaminobenzene, 2,6-diaminotoluene, 2,4-diaminotoluene, benzidine, 3,3′-dimethylbenzidine, naphthalenediamines, and mixtures thereof.

11. A composition according to claim 1 wherein the polyimide comprises the recurring unit 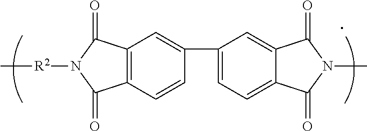
wherein R² is selected from the group consisting of p-phenylene radicals, 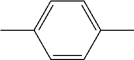
m-phenylene radicals, 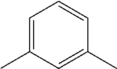
and a mixture thereof.

12. A composition according to claim 11 wherein greater than 60 to about 85 mol % of the R² groups comprise p-phenylene radicals, and about 15 to less than 40 mol % comprise m-phenylene radicals.

13. A composition according to claim 11 wherein about 70 mol % of the R² groups comprise p-phenylene radicals and about 30 mol % of the R² groups comprise m-phenylene radicals.

14. A composition according to claim 1 wherein the polyimide comprises less than 10 mol % of linkages therein selected from the group consisting of —O—, —N(H)—C(O)—, —S—, —SO₂—, —C(O)—, —C(O)—O—, —C(CH₃)₂—, —C(CF₃)₂—, —(CH₂)—, and —NH(CH₃)—.

15. A composition according to claim 1 further comprising a component (d) that comprises about 5 wt % to about 70 wt % [based on the weight of the total (a)+(b)+(c)+(d) composition] of one or more additives selected from the members of the group consisting of pigments; antioxidants; materials to impart a lowered coefficient of thermal expansion; materials to impart high strength properties; materials to impart heat dissipation or heat resistance properties; materials to impart corona resistance; materials to impart electric conductivity; and materials to reduce wear or coefficient of friction.

16. An article comprising a composition according to claim 1.

17. An article according to claim 16 which is fabricated as a bushing, seal ring, spring, valve seat, vane, washer, button, roller, clamp, washer, gasket, spline, wear strip, bumper, slide block, spool, poppet, valve plate, labyrinth seal or thrust plug.
